(19) United States
(12) Patent Application Publication
(10) Pub. No.: US 2025/0318010 A1
(43) Pub. Date: Oct. 9, 2025

(54) METHOD AND APPARATUS FOR SUPPORTING INACTIVE STATE OF SYNCHRONIZATION SIGNAL AND BROADCAST CHANNEL TRANSMISSION

(71) Applicant: ELECTRONICS AND TELECOMMUNICATIONS RESEARCH INSTITUTE, Daejeon (KR)

(72) Inventors: Jung-Bin KIM, Daejeon (KR); Pansoo KIM, Daejeon (KR); Gyeongrae IM, Daejeon (KR)

(73) Assignee: ELECTRONICS AND TELECOMMUNICATIONS RESEARCH INSTITUTE, Daejeon (KR)

(21) Appl. No.: 19/097,455

(22) Filed: Apr. 1, 2025

(30) Foreign Application Priority Data
Apr. 5, 2024 (KR) 10-2024-0047002
Mar. 19, 2025 (KR) 10-2025-0035290

(51) Int. Cl. H04W 76/28; H04B 7/06; H04W 52/02; H04W 76/27

(52) U.S. Cl. CPC H04W 76/28; H04B 7/06952; H04W 52/0216; H04W 76/27

(57) ABSTRACT

A method of a terminal may comprise: receiving synchronization signal block (SSB) configuration information from a base station; identifying information of an inactive state in which SSB transmission is deactivated from the SSB configuration information; and suspending an SSB reception operation in an inactive period according to the information on the inactive state.

### CROSS-REFERENCE TO RELATED APPLICATIONS

This application claims priority to Korean Patent Applications No. 10-2024-0047002, filed on Apr. 5, 2024, and No. 10-2025-0035290, filed on Mar. 19, 2025, with the Korean Intellectual Property Office (KIPO), the entire contents of which are hereby incorporated by reference.

### BACKGROUND

### 1. Technical Field

The present disclosure relates to a technique for supporting an inactive state of synchronization signal and broadcast channel transmission in a communication system, and more particularly, to a technique for a terminal to suspend synchronization signal block (SSB) reception when a beam is in an inactive state.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In the 5G communication system, synchronization signal blocks (SSBs) may be transmitted at a periodicity ranging from a minimum of 5 ms to a maximum of 160 ms. A terminal may attempt to receive the SSB according to an SSB transmission periodicity configured for the terminal. However, in a satellite communication system utilizing large-scale multiple beams, the number of beams that can be simultaneously used may be limited, and there may be beams whose use is temporarily suspended. The terminal may not be able to receive SSBs at configured SSB reception times during a time when the use of the beams is temporarily suspended. The terminal may fail to receive the SSBs as well as some downlink signals. The terminal may fail to receive all downlink signals. The terminal may fail to transmit some uplink signals or all uplink signals. A base station may fail to transmit some or all downlink signals to the terminal. The base station may fail to receive some or all uplink signals from the terminal. For example, if the time during which the use of beams is temporarily suspended is several hundred milliseconds or longer, the terminal may periodically perform a reception operation of synchronization signals (SSs) for a long period. In this case, battery consumption of the terminal may be induced. If a result of performing the reception operation is considered a communication connection failure, all terminals belonging to a corresponding beam may attempt initial accesses.

### SUMMARY

The present disclosure for resolving the above-described problems is directed to providing a method and an apparatus for supporting an inactive state of synchronization signal and broadcast channel transmission.

A method of a terminal, according to exemplary embodiments of the present disclosure, may comprise: receiving synchronization signal block (SSB) configuration information from a base station; identifying information of an inactive state in which SSB transmission is deactivated from the SSB configuration information; and suspending an SSB reception operation in an inactive period according to the information on the inactive state.

The information on the inactive state may include at least one of information on a number of SSB transmissions during a time period when the SSB transmission is possible or information on an inactive time duration of the SSB transmission.

The SSB configuration information may be included in at least one of a system information block 1 (SIB1), a radio resource control (RRC) message, or an SIB 19 transmitted from the base station to the terminal.

The method may further comprise: when the SSB configuration information includes information on a second SSB transmission periodicity, switching a periodicity of the SSB transmission from a preset first SSB transmission periodicity to the second SSB transmission periodicity before suspending the SSB reception operation, wherein the inactive period may be determined by the second SSB transmission periodicity.

The second SSB transmission periodicity may be set to be longer than the first SSB transmission periodicity.

The method may further comprise: before the SSB transmission is transitioned from the inactive state to an active state, receiving, from the base station, information indicating that the periodicity of the SSB transmission has been switched from the second SSB transmission periodicity to the first SSB transmission periodicity; and periodically receiving SSBs according to the first SSB transmission periodicity using the information indicating that the periodicity of the SSB transmission has been switched from the second SSB transmission periodicity to the first SSB transmission periodicity.

The information on the inactive state may include at least one of a parameter indicating that the SSB transmission is to be deactivated, a parameter indicating a start point of the inactive state, or a parameter indicating the inactive period from the start point.

The information on the inactive state may include beam configuration information and hopping pattern information related to beam hopping in an area where the terminal is located, and the identifying of the information on the inactive state may comprise: estimating the inactive period in which the SSB transmission is deactivated using the beam configuration information and the hopping pattern information.

The information on the inactive state may include a parameter indicating whether to suspend transmission and reception of at least some signals including SSBs, and the identifying of the information on the inactive state may comprise: estimating the inactive period in which the SSB transmission is deactivated using the parameter.

The SSB configuration information may be included in configuration-related information for an inactive period of cell discontinuous transmission (DTX) and discontinuous reception (DRX).

A terminal, according to exemplary embodiments of the present disclosure, may comprise at least one processor, and the at least one processor may cause the terminal to perform: receiving synchronization signal block (SSB) configuration information from a base station; identifying information of an inactive state in which SSB transmission is deactivated from the SSB configuration information; and suspending an SSB reception operation in an inactive period according to the information on the inactive state.

The information on the inactive state may include at least one of information on a number of SSB transmissions during a time period when the SSB transmission is possible or information on an inactive time duration of the SSB transmission.

The SSB configuration information may be included in at least one of a system information block 1 (SIB1), a radio resource control (RRC) message, or an SIB 19 transmitted from the base station to the terminal.

When the SSB configuration information includes information on a second SSB transmission periodicity, the at least one processor may further cause the terminal to perform: switching a periodicity of the SSB transmission from a preset first SSB transmission periodicity to the second SSB transmission periodicity before suspending the SSB reception operation, wherein the inactive period may be determined by the second SSB transmission periodicity.

The second SSB transmission periodicity may be set to be longer than the first SSB transmission periodicity.

The at least one processor may further cause the terminal to perform: before the SSB transmission is transitioned from the inactive state to an active state, receiving, from the base station, information indicating that the periodicity of the SSB transmission has been switched from the second SSB transmission periodicity to the first SSB transmission periodicity; and periodically receiving SSBs according to the first SSB transmission periodicity using the information indicating that the periodicity of the SSB transmission has been switched from the second SSB transmission periodicity to the first SSB transmission periodicity.

The information on the inactive state may include at least one of a parameter indicating that the SSB transmission is to be deactivated, a parameter indicating a start point of the inactive state, or a parameter indicating the inactive period from the start point.

The information on the inactive state may include beam configuration information and hopping pattern information related to beam hopping in an area where the terminal is located, and in the identifying of the information on the inactive state, the at least one processor may further cause the terminal to perform: estimating the inactive period in which the SSB transmission is deactivated using the beam configuration information and the hopping pattern information.

The information on the inactive state may include a parameter indicating whether to suspend transmission and reception of at least some signals including SSBs, and in the identifying of the information on the inactive state, the at least one processor may further cause the terminal to perform: estimating the inactive period in which the SSB transmission is deactivated using the parameter.

The SSB configuration information may be included in configuration-related information for an inactive period of cell discontinuous transmission (DTX) and discontinuous reception (DRX).

According to the present disclosure, an inactive state of SSB transmission may be supported in a mobile communication system using large-scale multiple beams. When the state of SSB transmission is in the inactive state, unnecessary transitions of a terminal to communication connection failure, malfunction of the terminal and a base station, and battery consumption of the terminal may be prevented. In the mobile communication system using large-scale multiple beams, when an inactive state exists in which transmission and reception of some or all uplink and downlink signals, including SSBs, are impossible, unnecessary transitions of the terminal to communication connection failure may be prevented. Furthermore, when a beam transitions from the inactive state to an active state, unnecessary reattempts of initial access by the terminal may be prevented. Connection delay may be reduced, and transmission rate may be improved. The present disclosure may also be applied to a general terrestrial network environment rather than a large-scale multiple beam environment. The present disclosure may also be used to operate interruption periods of some or all signals, including SSBs, in a cell DTX/DRX environment.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram for describing SSB transmission times in a 5G communication system utilizing multiple beams.

FIG. 4 is a conceptual diagram for describing a satellite communication system utilizing multiple beams.

FIG. 5 is a sequence chart for describing a method in which a base station provides a terminal with information on an inactive state of SSB transmission through a system information block 1 (SIB1).

FIG. 6 is a sequence chart for describing a method for supporting an inactive state of SSB transmission by using multiple SSB transmission periodicities.

FIG. 7 is a sequence chart for describing a method in which a base station provides a terminal with a start point and duration of an inactive state of SSB transmission using RRC information.

FIG. 8 is a sequence chart for describing a method in which a base station transmits beam hopping configuration information to a terminal to suspend SSB reception.

FIG. 9 is a sequence chart for describing a method in which a base station transmits cell DTX/DRX configuration-related information to a terminal to suspend SSB reception.

FIG. 10 is a flowchart for describing a process in which a terminal suspends SSB reception operations.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the 5G communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

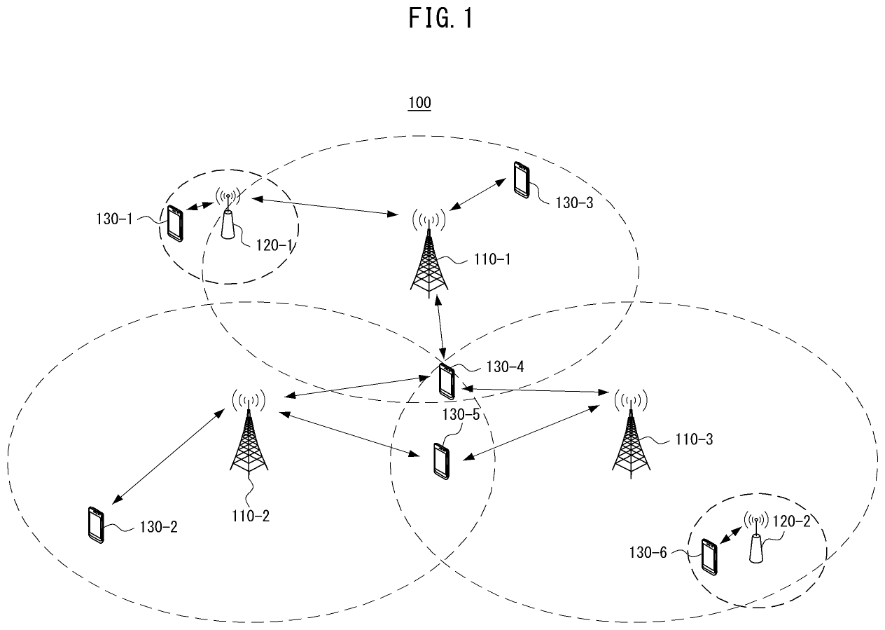

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

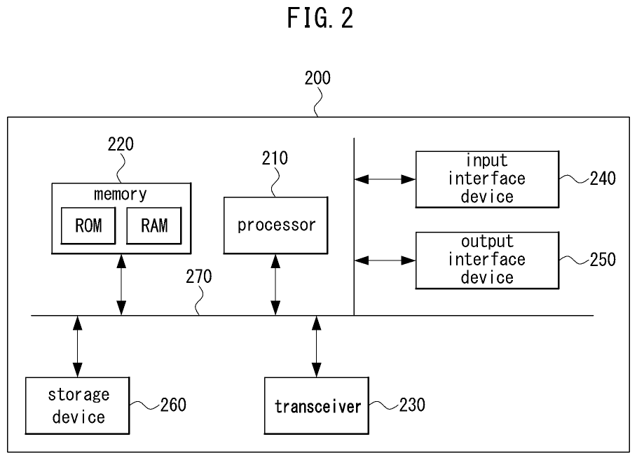

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

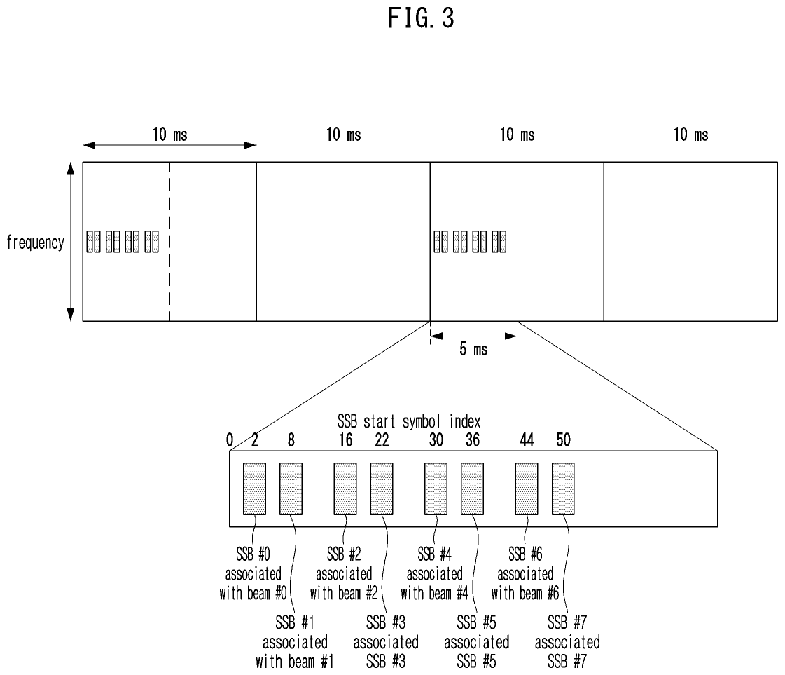

FIG. 3 is a conceptual diagram for describing SSB transmission times in a 5G communication system utilizing multiple beams.

Referring to FIG. 3, in a wireless mobile communication system, a terminal may acquire time and frequency synchronization with a cell to access the cell for cell-based communication. The terminal may perform cell search to obtain a physical layer cell identifier (PCI) of the cell to be accessed. A base station of the cell may transmit synchronization signal/physical broadcast channel (SS/PBCH) blocks to the terminal. In the cell search, the terminal may receive the SS/PBCH block transmitted from the base station of the cell and obtain information required for accessing the cell. When multi-beam transmission and reception between the base station and the terminal is possible, the base station may periodically transmit SS/PBCH blocks in which different beams are respectively applied during a specific time period. The terminal may receive the SS/PBCH blocks in which different beams are respectively applied. The terminal may select a beam having the highest received signal strength among the different beams.

For example, in the 5G communication system, synchronization signals may be defined as a primary synchronization signal (PSS) and a secondary synchronization signal (SSS). The synchronization signals may be defined in a synchronization signal block (SSB) composed of the PSS, the SSS, and a PBCH. The base station may periodically transmit the SSBs. The terminal may receive the SSB from the base station to obtain information required for accessing the cell. The SSB transmission times shown in FIG. 3 may correspond to transmission times when a carrier frequency is in a range of 3 GHz to 6 GHz and a subcarrier spacing is 15 kHz. A total of 8 SSBs (i.e. SSB #0 to SSB #7) may be transmitted during a 5 ms period using respective different beams (i.e. beam #0 to beam #7). The 8 SSBs may be transmitted at a periodicity of 20 ms. The terminal may obtain a PCI by using the PSS and SSS within the SSB. The terminal may obtain essential information on the cell by using the PBCH. In information transmitted on the PBCH, a 56-bit payload of the PBCH may include the contents of Table 1.

TABLE 1

| Information | Number of bits |
|---|---|
| System frame number | 10 |
| Subcarrier spacing | 1 |
| SSB subcarrier offset | 5 (FR1) or 4 (FR2) |
| DMRS-type-A-position | 1 |
| PDCCH configuration for SIB1 | 8 |
| Cell barring information flag | 1 |
| Intra-frequency reselection allowed/ | 1 |
| not allowed flag) | |
| SSB index | 0 (FR1) or 3 (FR2) |
| Half-frame bit | 1 |
| Spare bits | 1 |
| Reserved bits | 2 (FR1) or 0 (FR2) |
| BCCH-BCH-message type indication | 1 |
| CRC bits | 24 |

FR1 may refer to a frequency range 1 (FR1), which indicates a band below 6 GHz. FR2 may refer to a frequency range 2 (FR2), which indicates a band above 24 GHz. Referring to FIG. 3, the terminal may identify information on an SSB start symbol index (hereinafter, SSB index information) by using 8 scrambling sequences of the PBCH in the case of FR1. The terminal may distinguish up to 64 SSB indexes in the case of FR2 by using both the 8scrambling sequences of the PBCH and 3-bit SSB index information transmitted on the PBCH, and may identify each SSB index.

Only a subset of all SSBs may be transmitted. Information on the actually-transmitted SSBs may be obtained by using at least one of 8-bit inOneGroup information and 8-bit groupPresence information in an ssb-PositionsInBurst field of a ServingCellConfigCommonSIB included in a system information block 1 (SIB1). Alternatively, information on the actually-transmitted SSBs may be obtained by using at least one of 4-bit shortBitmap information, 8-bit mediumBitmap information, or 64-bit longBitmap information in an ssb-PositionsInBurst field of ServingCellConfigCommon provided through radio resource control (RRC) reconfiguration signaling. In case of a standalone 5G system, information on SSB transmission may be transmitted through the SIB1. In case of a non-standalone 5G system, information on SSB transmission may be transmitted through an RRC reconfiguration message. For example, the information on SSB transmission in the SIB1 may be as shown in Table 2. For example, information on SSB transmission in the RRC reconfiguration message may be as shown in Table 3.

TABLE 2
ServingCellConfigCommonSIB

| | | |
|---|---|---|
| ssb-PositionsInBurst | inOneGroup | BIT STRING (SIZE (8) |
| | groupPresence | BIT STRING (SIZE (8)) |

| | |
|---|---|
| ssb-periodicityServingCell | ENUMERATED {5 ms, 10 ms, 20 ms, 40 ms, 80 ms, |
| | 160 ms} |

TABLE 3
ServingCellConfigCommon

| | | |
|---|---|---|
| ssb-PositionsInBurst | shortBitmap | BIT STRING (SIZE (4)) |
| | mediumBitmap | BIT STRING (SIZE (8)) |
| | longBitmap | BIT STRING (SIZE (64)) |

| | |
|---|---|
| ssb-periodicityServingCell | ENUMERATED {5 ms, 10 ms, 20 ms, 40 ms, 80 ms, |
| | 160 ms, spare2, spare1} |

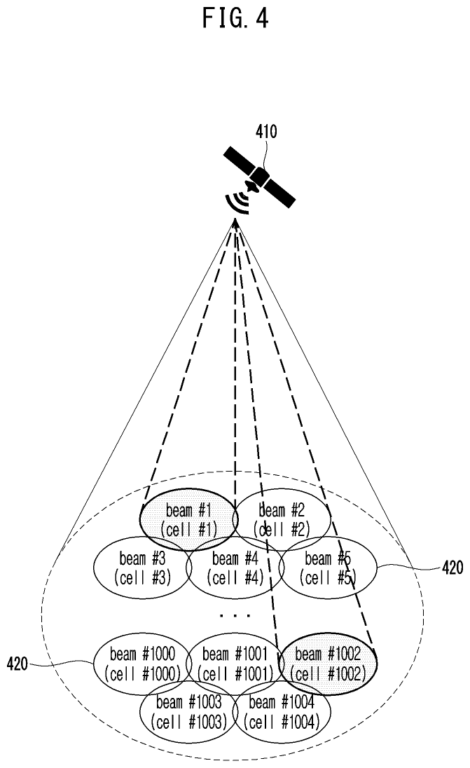

FIG. 4 is a conceptual diagram for describing a satellite communication system utilizing multiple beams.

Referring to FIG. 4, in a satellite communication system utilizing multiple beams, each beam may be allocated to a spatially different area. For example, a first beam (i.e. beam #1) may be allocated to a corresponding first cell (i.e. cell #1). A second beam (i.e. beam #2) may be allocated to a corresponding second cell (i.e. cell #2). Terminals located within each beam coverage 420 of a satellite 410 may obtain synchronization signals and system information for a cell corresponding to each beam through SSB(s).

Various constraints, such as restrictions on a transmission power and restrictions on beam management and operations, may exist for the satellite 410. If the number of beams that the satellite 410 can support reaches hundreds or even thousands, the number of beams that can be simultaneously used (i.e. the number of beams simultaneously activated) may be limited due to the constraints of the satellite. In order for the satellite to provide services to terminals of hundreds or thousands within the beam coverage, methods such as beam hopping may be utilized. The beam hopping may be applied on a time-division basis. For example, all beams may be divided into several groups. The respective groups may be switched in a time-division manner so that only a subset of beams is activated at the same time. However, when the beam to which the terminal is connected is not in use (i.e., not activated), the terminal may be unable to receive synchronization signals and system information such as SSBs.

The terminal may be unable to receive SSBs as well as some downlink signals. The terminal may be unable to receive all downlink signals. The terminal may be unable to transmit some uplink signals or all uplink signals. The base station may also be unable to transmit some or all downlink signals to the terminal. The base station may be unable to receive some or all uplink signals from the terminal.

To address the above-described issue, when an inactive state of SSB transmission exists in the wireless mobile communication system utilizing large-scale multiple beams, a method may be provided to prevent the terminal from being unnecessarily transitioned to a communication connection failure. A method may be provided to prevent malfunctions of the terminal and the base station, as well as to reduce battery consumption of the terminal. A transmission and reception method for supporting the above-described methods may be provided. The methods may be applied even when an inactive state exists in which transmission and reception of some or all uplink and downlink signals, including SSBs, are not possible. The methods may be applied not only to a large-scale multi-beam operation environment but also to a general terrestrial network environment. For example, the methods may be used to manage an interruption period of signals, including SSBs, in cell discontinuous transmission/discontinuous reception (DTX/DRX). The meaning of an inactive state of SSB transmission may be interpreted as including inactivation of some or all uplink and downlink signals. Hereinafter, information for providing an inactive state of SSB transmission to the terminal and a method for transmitting and receiving the information will be described.

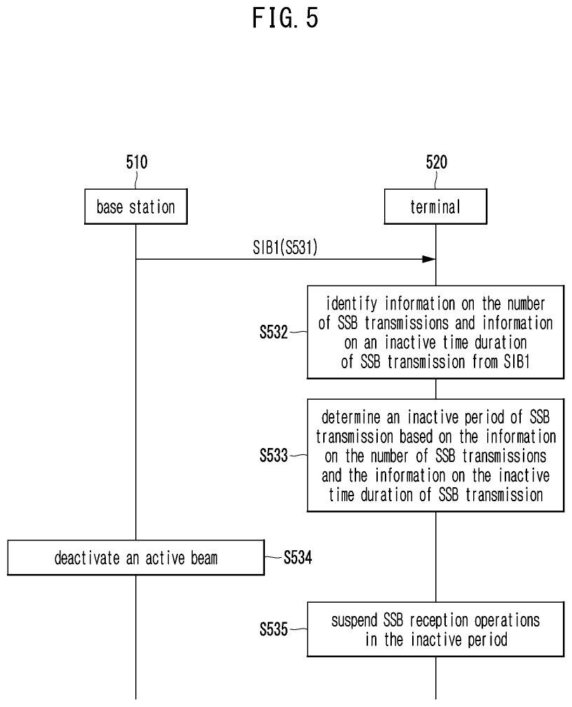

FIG. 5 is a sequence chart for describing a method in which a base station provides a terminal with information on an inactive state of SSB transmission through a system information block 1 (SIB1).

Referring to FIG. 5, a base station may transmit a specific beam. A terminal may receive the specific beam transmitted by the base station. The terminal may identify an SSB transmission time through the SIB1 of the specific beam. However, even when SSB transmission is in an inactive state for a specific period due to beam usage restrictions, the terminal may periodically attempt SSB reception. Alternatively, when SSB transmission is in the inactive state, the terminal may mistakenly recognize a communication connection failure and perform an undesired operation such as an initial access attempt. When the SSB transmission is in the inactive state, the base station may transmit information on an inactive period of SSB transmission (i.e. a period during which the SSB transmission is inactive) to the terminal to prevent the terminal from performing an undesired operation. The terminal may use the information on the inactive period of SSB transmission to suspend SSB receptions in the inactive period.

For example, the inactive period of SSB transmission may be defined using a last SSB transmission time and an inactive time duration of SSB transmission. The last SSB transmission time may be determined based on the number of SSB transmissions. The number of SSB transmissions may be determined through the SSB transmission periodicity. In other words, a time period during which SSB(s) can be received may be determined as a value obtained by multiplying the SSB transmission periodicity by the number of SSB transmissions. The time period during which the SSB(s) can be received may exist within a period during which the corresponding beam can be used. To determine the time period during which the SSB(s) can be received, information on the number of SSB transmissions during the time period in which SSB transmission is possible and information on the inactive time duration of SSB transmission may be added to the SIB1. The information included in SIB1 may be as shown in Table 4.

TABLE 4
ServingCellConfigCommonSIB

| | | |
|---|---|---|
| ssb-PositionsInBurst | inOneGroup | BIT STRING (SIZE (8)) |
| | groupPresence | BIT STRING (SIZE (8)) |

| | |
|---|---|
| ssb-periodicityServingCell | ENUMERATED {5 ms, 10 ms, 20 ms, 40 ms, 80 ms, |
| | 160 ms} |
| ssb-numTx | INTEGER {1, . . . , 32} |
| ssb-inactiveDuration | ENUMERATED {320 ms, 480 ms, 640 ms, 800 ms, |
| | 960 ms, 1120 ms} |

In the SIB1, ssb-mimTx may indicate the number of SSB transmissions during the time period in which SSB transmission is possible, and ssb-inactiveDuration may indicate the inactive time duration of SSB transmission. Candidate values of ssb-numTx, which range from 1 to 32, may be modified to other candidate ranges. For example, the candidate values may be given as specific values such as {1, 2, 5, 10, 20}. The candidate values of ssb-inactive Duration may also be set to values other than {320 ms, 480 ms, 640 ms, 800 ms, 960 ms, 1120 ms}.

The base station 510 may transmit the SIB1 to the terminal 520 (S531). In other exemplary embodiments, the base station may transmit an RRC message (e.g. RRC reconfiguration message) or SIB19 to the terminal instead of the SIB1. The terminal 520 may receive the SIB1 (or RRC message, SIB19) from the base station 510. The terminal 520 may identify the number of SSB transmissions and the inactive time duration of SSB transmission from the SIB1 (S532). The terminal 520 may determine the inactive period of SSB transmission based on the number of SSB transmissions and the inactive time duration of SSB transmission (S533). The base station 510 may deactivate an active beam (S534). The terminal 520 may suspend SSB reception operation during the inactive period (S535).

When an RRC message is used, the information included in the RRC message may be as shown in Table 5. The definitions and candidate values of ssb-numTx and ssb-inactive Duration in the RRC message may be the same as those in the SIB1. When the SIB19 is used, information included in the SIB19 may be as shown in Table 6. The definitions and candidate values of ssb-numTx and ssb-inactiveDuration in the SIB19 may be the same as those in the SIB1.

TABLE 5
ServingCellConfigCommon

| | | |
|---|---|---|
| ssb-PositionsInBurst | shortBitmap | BIT STRING (SIZE (4)) |
| | mediumBitmap | BIT STRING (SIZE (8)) |
| | longBitmap | BIT STRING (SIZE (64)) |

| | |
|---|---|
| ssb-periodicityServingCell | ENUMERATED {5 ms, 10 ms, 20 ms, 40 ms, 80 ms, |
| | 160 ms, spare2, spare1} |
| ssb-numTx | INTEGER {1, . . . , 32} |
| ssb-inactiveDuration | ENUMERATED {320 ms, 480 ms, 640 ms, 800 ms, |
| | 960 ms, 1120 ms} |

TABLE 6
NTN-Config-r17

| | |
|---|---|
| cellSpecificKoffset-r17 | INTEGER(0 . . . 1023) |
| kmac-r17 | INTEGER(0 . . . 512) |
| ta-Info-r17 | TAInfo-r17 |
| ssb-numTx | INTEGER {1, . . . , 32} |
| ssb-inactiveDuration | ENUMERATED {320 ms, 480 ms, 640 ms, |
| | 800 ms, 960 ms, 1120 ms} |

The SIB19 may include information for supporting a satellite network (non-terrestrial network). Methods using the SIB1, RRC message, or SIB 19 may be applied in a non-terrestrial network. The terminal may determine whether the network to which it is connected is a non-terrestrial network through a PBCH. The terminal connected to the non-terrestrial network may receive the SIB1, RRC message, or SIB19. The methods may be applied to various systems supporting the inactive state of SSB transmission.

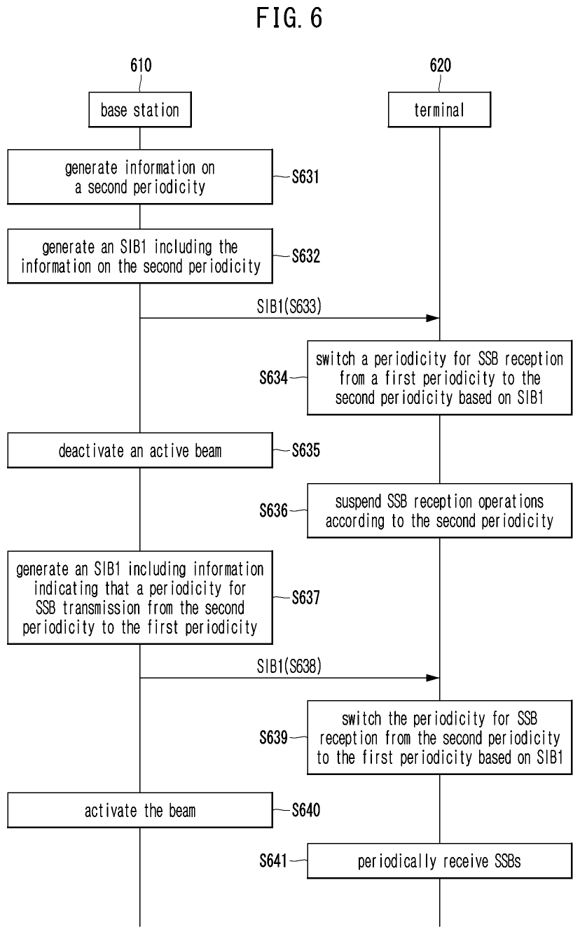

FIG. 6 is a sequence chart for describing a method for supporting an inactive state of SSB transmission by using multiple SSB transmission periodicities.

Referring to FIG. 6, a base station 610 may generate information on a second SSB transmission periodicity (hereinafter, a second periodicity) that is longer than a first SSB transmission periodicity (hereinafter, a first periodicity) (S631). Before deactivating an active beam, the base station 610 may generate an SIB1 including information on the second periodicity (S632). The second periodicity may correspond to a next period in which the beam is reactivated. In other words, the second periodicity may correspond to a period from a last point of the current active period of the beam to a start point of the next active period. The base station 610 may transmit the SIB1 to a terminal 620 (S633). The terminal 620 may receive the SIB1 from the base station 610. The terminal 620 may switch a periodicity for SSB reception from the first periodicity to the second periodicity based on the SIB1 (S634). The base station 610 may deactivate the active beam (S635). The terminal 620 may suspend SSB reception during the inactive period corresponding to the second periodicity (S636). The base station 610 may generate an SIB1 including information indicating that the SSB transmission periodicity has switched from the second periodicity back to the original periodicity, which is the first periodicity (S637). The base station (610) may transmit the SIB1 to the terminal 620 (S638). The terminal 620 may receive the SIB1 from the base station 610. The terminal 620 may switch the periodicity for SSB reception from the second periodicity back to the original periodicity, which is the first periodicity, based on the SIB1 (S639). The base station 610 may activate the beam (S640). The terminal 620 may periodically receive SSBs during the SSB active period according to the first periodicity (S641).

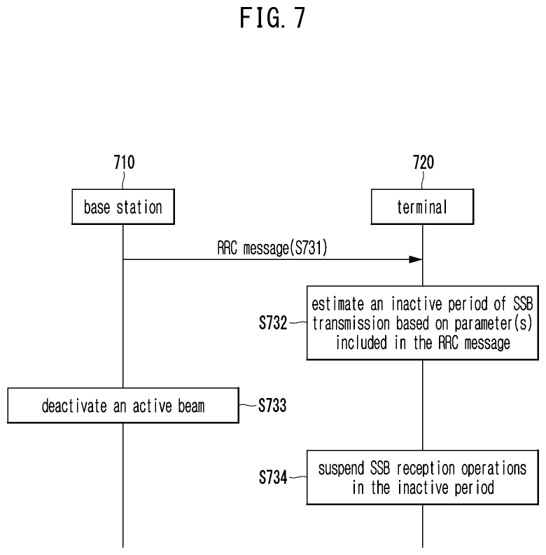

FIG. 7 is a sequence chart for describing a method in which a base station provides a terminal with a start point and duration of an inactive state of SSB transmission using RRC information.

Referring to FIG. 7, a base station 710 may transmit an RRC message (e.g. RRC reconfiguration message) to a terminal 720 (S731). The terminal 720 may receive the RRC message from the base station 710. The RRC message may include at least one of a parameter indicating that SSB transmission is to be deactivated, a parameter indicating a start point of the inactive state, or a parameter indicating an inactive period from the start point. The terminal 720 may estimate the inactive period of SSB transmission using the at least one parameter included in the RRC message (S732). The base station 710 may deactivate an active beam (S733). The terminal 720 may suspend the SSB reception operations during the inactive period (S734).

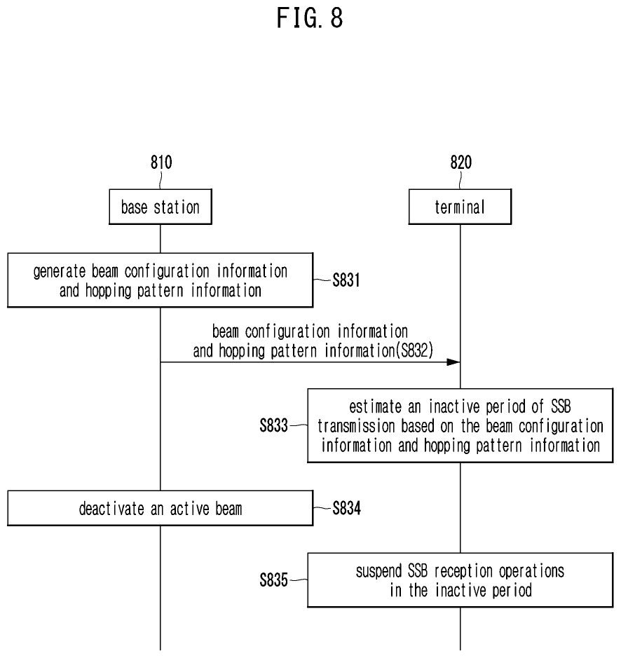

FIG. 8 is a sequence chart for describing a method in which a base station transmits beam hopping configuration information to a terminal to suspend SSB reception.

Referring to FIG. 8, a base station 810 may configure beam configuration information and hopping pattern information related to beam hopping in an area where a terminal 820 is located (S831). The base station 810 may transmit the beam configuration information and the hopping pattern information to the terminal 820 (S832). The base station 810 may transmit the beam configuration information and the hopping pattern information to the terminal 820 through RRC reconfiguration information, an SIB 19, or a new SIB. The terminal 820 may receive the beam configuration information and the hopping pattern information from the base station 810. The terminal 820 may estimate an inactive period, which is a period during which SSB transmission is deactivated, by using the beam configuration information and the hopping pattern information (S833). The base station 810 may deactivate an active beam (S834). The terminal 820 may suspend SSB reception operations during the inactive period (S835).

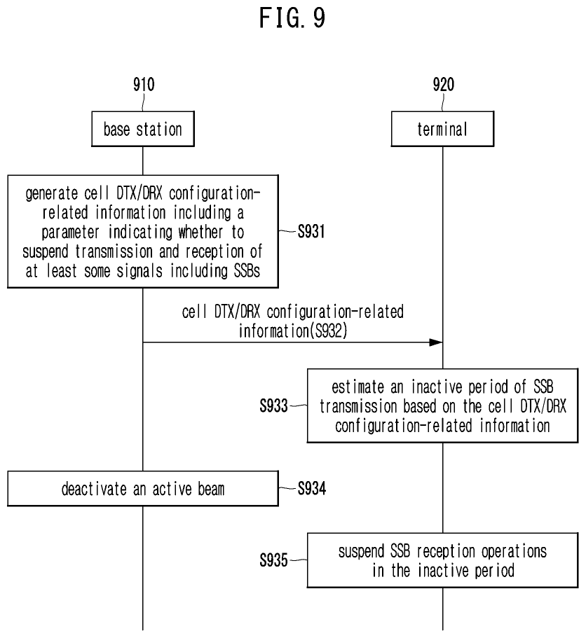

FIG. 9 is a sequence chart for describing a method in which a base station transmits cell DTX/DRX configuration-related information to a terminal to suspend SSB reception.

Referring to FIG. 9, a base station 910 may generate configuration-related information of an inactive period (hereinafter, cell discontinuous transmission (DTX)/discontinuous reception (DRX) configuration-related information) of cell DTX/DRX, which includes a parameter indicating whether to suspend transmission and reception of at least a part of signals including SSBs or all uplink and downlink signals (S931). The base station 910 may transmit the cell DTX/DRX configuration-related information to a terminal 920 (S932). The base station 910 may transmit the cell DTX/DRX configuration-related information to the terminal 920 through RRC reconfiguration information, an SIB 19, or a new SIB. The terminal 920 may receive the cell DTX/DRX configuration-related information from the base station 910.

The terminal 920 may estimate an inactive period of SSB transmission by using the cell DTX/DRX configuration-related information (S933). The base station 910 may deactivate an active beam (S934). The terminal 920 may suspend SSB reception operations during the inactive period (S935).

The methods described with reference to FIGS. 5 to 9 may be applied to various systems that support the inactive state of SSB transmission. The methods described with reference to FIGS. 5 to 9 may also be used in combination to support the inactive state of SSB transmission.

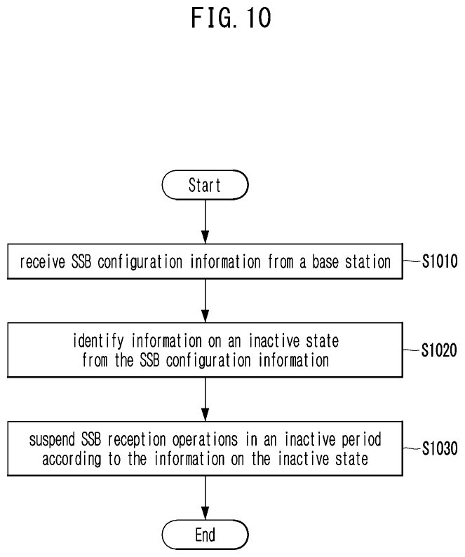

FIG. 10 is a flowchart for describing a process in which a terminal suspends SSB reception operations.

Referring to FIG. 10, a base station may transmit information on SSB transmission (i.e. SSB configuration information) to a terminal. For example, the SSB configuration information may be included in at least one of an SIB 1, an RRC message, an SIB 19, or another SIB. The terminal may receive the SSB configuration information from the base station (S1010). For example, the SSB configuration information may include at least one of the pieces of information in Table 4, Table 5, or Table 6. The terminal may identify information on an inactive state in which SSB transmission is deactivated from the SSB configuration information (S1020). The information on the inactive state may include at least one of information on the number of SSB transmissions during a period in which SSB transmission is possible and information on an inactive time duration of SSB transmission. The terminal may suspend SSB reception operations during the inactive period according to the information on the inactive state (S1030).

The SSB configuration information may include information on a second SSB transmission periodicity. Before step S1030, the terminal may switch a periodicity of SSB transmission (i.e. periodicity for SSB reception) from a preset first SSB transmission periodicity to the second SSB transmission periodicity. The second SSB transmission periodicity may be set to be longer than the first SSB transmission periodicity. Before the state of SSB transmission (i.e. a beam) transitions from the inactive state to an active state, the base station may generate information indicating that the SSB transmission periodicity has been switched from the second SSB transmission periodicity to the first SSB transmission periodicity. The base station may transmit information indicating that the SSB transmission periodicity has been switched from the second SSB transmission periodicity to the first SSB transmission periodicity to the terminal. The terminal may receive the information indicating that the SSB transmission periodicity has been switched from the second SSB transmission periodicity to the first SSB transmission periodicity from the base station. The terminal may periodically receive SSBs according to the first SSB transmission periodicity by using the information indicating that the SSB transmission periodicity has been switched from the second SSB transmission periodicity to the first SSB transmission periodicity.

The information on the inactive state may include at least one of a parameter indicating that SSB transmission is to be deactivated, a parameter indicating a start point of the inactive state, and a parameter indicating an inactive period from the start point. Alternatively, the information on the inactive state may include beam configuration information and hopping pattern information related to beam hopping in an area where the terminal is located. Step S1020 may be a step of estimating the inactive period in which SSB transmission is deactivated by using the beam configuration information and the hopping pattern information.

In another exemplary embodiment, step S1010 may be a step of receiving configuration-related information of an inactive period of cell DTX and DRX. In other words, the SSB configuration information may be included in the configuration-related information of the inactive period of cell DTX and DRX. At least one of the configuration-related information or the information on the inactive state may include a parameter indicating whether to suspend transmission and reception of at least a part of signals, including SSBs. Step S1020 may be a step of estimating the inactive period in which SSB transmission is deactivated by using the parameter indicating whether to suspend transmission and reception of at least a part of signals (or all uplink and downlink signals), including SSBs.

According to the present disclosure, when an inactive state of synchronization signal (SS) and broadcast channel (SSB) transmission exists in a wireless mobile communication system, a method and an apparatus for supporting a seamless communication connection between a base station and a terminal can be provided. The inactive state of SSB transmission may be a state in which only SSB transmission is deactivated, a state in which some uplink and downlink signals including SSBs are deactivated, or a state in which all uplink and downlink signals are deactivated.

According to the present disclosure, in a communication system using large-scale multiple beams, when an inactive state of SSB transmission exists, a method for preventing malfunction of a terminal and a base station, including a transition to communication connection failure, and battery consumption, and a transmission/reception method for supporting the method can be provided. According to the present disclosure, in a wireless mobile communication system using large-scale multiple beams, when an inactive state exists in which transmission and reception of some or all uplink and downlink signals, including an SSB, are impossible, a method for preventing malfunction of a terminal and a base station, including a transition to communication connection failure, and battery consumption, and a transmission/reception method for supporting the method can be provided.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving synchronization signal block (SSB) configuration information from a base station;
identifying information of an inactive state in which SSB transmission is deactivated from the SSB configuration information; and
suspending an SSB reception operation in an inactive period according to the information on the inactive state.

2. The method according to claim 1, wherein the information on the inactive state includes at least one of information on a number of SSB transmissions during a time period when the SSB transmission is possible or information on an inactive time duration of the SSB transmission.

3. The method according to claim 1, wherein the SSB configuration information is included in at least one of a system information block 1 (SIB1), a radio resource control (RRC) message, or an SIB 19 transmitted from the base station to the terminal.

4. The method according to claim 1, further comprising: when the SSB configuration information includes information on a second SSB transmission periodicity, switching a periodicity of the SSB transmission from a preset first SSB transmission periodicity to the second SSB transmission periodicity before suspending the SSB reception operation,
wherein the inactive period is determined by the second SSB transmission periodicity.

5. The method according to claim 4, wherein the second SSB transmission periodicity is set to be longer than the first SSB transmission periodicity.

6. The method according to claim 5, further comprising:
before the SSB transmission is transitioned from the inactive state to an active state, receiving, from the base station, information indicating that the periodicity of the SSB transmission has been switched from the second SSB transmission periodicity to the first SSB transmission periodicity; and
periodically receiving SSBs according to the first SSB transmission periodicity using the information indicating that the periodicity of the SSB transmission has been switched from the second SSB transmission periodicity to the first SSB transmission periodicity.

7. The method according to claim 1, wherein the information on the inactive state includes at least one of a parameter indicating that the SSB transmission is to be deactivated, a parameter indicating a start point of the inactive state, or a parameter indicating the inactive period from the start point.

8. The method according to claim 1, wherein the information on the inactive state includes beam configuration information and hopping pattern information related to beam hopping in an area where the terminal is located, and the identifying of the information on the inactive state comprises: estimating the inactive period in which the SSB transmission is deactivated using the beam configuration information and the hopping pattern information.

9. The method according to claim 1, wherein the information on the inactive state includes a parameter indicating whether to suspend transmission and reception of at least some signals including SSBs, and the identifying of the information on the inactive state comprises:
estimating the inactive period in which the SSB transmission is deactivated using the parameter.

10. The method according to claim 9, wherein the SSB configuration information is included in configuration-related information for an inactive period of cell discontinuous transmission (DTX) and discontinuous reception (DRX).

11. A terminal comprising at least one processor, wherein the at least one processor causes the terminal to perform:
receiving synchronization signal block (SSB) configuration information from a base station;
identifying information of an inactive state in which SSB transmission is deactivated from the SSB configuration information; and
suspending an SSB reception operation in an inactive period according to the information on the inactive state.

12. The terminal according to claim 11, wherein the information on the inactive state includes at least one of information on a number of SSB transmissions during a time period when the SSB transmission is possible or information on an inactive time duration of the SSB transmission.

13. The terminal according to claim 11, wherein the SSB configuration information is included in at least one of a system information block 1 (SIB1), a radio resource control (RRC) message, or an SIB 19 transmitted from the base station to the terminal.

14. The terminal according to claim 11, wherein when the SSB configuration information includes information on a second SSB transmission periodicity, the at least one processor further causes the terminal to perform: switching a periodicity of the SSB transmission from a preset first SSB transmission periodicity to the second SSB transmission periodicity before suspending the SSB reception operation,
wherein the inactive period is determined by the second SSB transmission periodicity.

15. The terminal according to claim 14, wherein the second SSB transmission periodicity is set to be longer than the first SSB transmission periodicity.

16. The terminal according to claim 15, wherein the at least one processor further causes the terminal to perform:
before the SSB transmission is transitioned from the inactive state to an active state, receiving, from the base station, information indicating that the periodicity of the SSB transmission has been switched from the second SSB transmission periodicity to the first SSB transmission periodicity; and
periodically receiving SSBs according to the first SSB transmission periodicity using the information indicating that the periodicity of the SSB transmission has been switched from the second SSB transmission periodicity to the first SSB transmission periodicity.

17. The terminal according to claim 11, wherein the information on the inactive state includes at least one of a parameter indicating that the SSB transmission is to be deactivated, a parameter indicating a start point of the inactive state, or a parameter indicating the inactive period from the start point.

18. The terminal according to claim 11, wherein the information on the inactive state includes beam configuration information and hopping pattern information related to beam hopping in an area where the terminal is located, and in the identifying of the information on the inactive state, the at least one processor further causes the terminal to perform: estimating the inactive period in which the SSB transmission is deactivated using the beam configuration information and the hopping pattern information.

19. The terminal according to claim 11, wherein the information on the inactive state includes a parameter indicating whether to suspend transmission and reception of at least some signals including SSBs, and in the identifying of the information on the inactive state, the at least one processor further causes the terminal to perform: estimating the inactive period in which the SSB transmission is deactivated using the parameter.

20. The terminal according to claim 19, wherein the SSB configuration information is included in configuration-related information for an inactive period of cell discontinuous transmission (DTX) and discontinuous reception (DRX).
